(19) United States
(12) Patent Application Publication
(10) Pub. No.: US 2011/0206578 A1
(43) Pub. Date: Aug. 25, 2011

(54) Treatment of metal oxide surfaces

(75) Inventors: Evan Foster, San Mateo, CA (US); Jessica Reed, Newark, CA (US); Heather Shepherd, Oakland, CA (US); Christina Inman, San Mateo, CA (US); Scott Benson, Alameda, CA (US)

(73) Assignee: LIFE TECHNOLOGIES CORPORATION, Carlsbad, CA (US)

(21) Appl. No.: 13/033,206

(22) Filed: Feb. 23, 2011

Related U.S. Application Data
(60) Provisional application No. 61/307,109, filed on Feb. 23, 2010.

(51) Int. Cl. B01L 9/00; B05D 3/10; B05D 3/06; B05D 7/22; B05D 3/00

(52) U.S. Cl. 422/563; 427/331; 427/343; 427/539; 427/299; 427/230; 427/444

(57) ABSTRACT

Methods for activating and/or reactivating a metal oxide surface for deposition, immobilizing, and/or growing a biological sample (e.g., an oligonucleotide, a polynucleotide, functionalized particle, a polymer, etc.) thereon are disclosed. The metal oxide surface (e.g., zirconium oxide) can be activated and/or reactivated by exposing the metal oxide surface to various activation and/or treatment protocols capable of enhancing a slide's activity relative to the activity of an untreated slide. The activation and/or treatment protocol can include subjecting the slide (or at least the metal oxide layer) to an oxygen plasma treatment and/or a peroxide solution for an amount of time sufficient to activate and/or reactivate the metal oxide surface. Activated sequencing slides capable of incorporation, for example, into various embodiments of a flow cell for use in NGS platforms are also disclosed herein.

### RELATED APPLICATION(S)

This application claims priority pursuant to 35 U.S.C. §119(e) to U.S. Provisional Patent Application Ser. No. 61/307,107, entitled “Treatment of Metal Oxide Surface,” filed on Feb. 23, 2010, the entirety of which is incorporated herein by reference.

### FIELD

The present disclosure generally relates to the field of treating and/or chemically-modifying surfaces and supports, including activation and/or reactivation of surfaces or supports (e.g., metal oxide or passivated surfaces) prior to the deposition, immobilization, restraint, growth, or association of particles, solid supports, biological samples, polymers, and other materials on such surfaces.

### BACKGROUND

Many Next Generation Sequencing (“NGS”) techniques focus on improving sequencing accuracy, increasing throughput, and reducing sequencing costs. Current NGS platforms provide for preparation, detection, imaging, analysis, and/or sequencing of large quantities of complex samples, including nucleic acids from entire genomes in single sequencing processes or instrument runs.

One thing in common with most NGS platforms is that large numbers of samples are typically immobilized, restrained, deposited, grown, or associated with, on, or in, or relative to a surface. NGS platforms perform various processes for obtaining information relating to sequence of nucleic acids in the samples. For example, various systems utilize sequencing by synthesis, sequencing by hybridization, sequencing by ligation, single-molecule sequencing, and/or various other techniques to obtain sequence-related information. NGS sequencing techniques and processes can include multiple steps involving fluid flow, reactions, and data acquisition from the samples that are immobilized, restrained, deposited, grown or associated with, on, in, or relative to surfaces and supports.

### SUMMARY

In some aspects, the present disclosure relates to improving the ability of a surface or support to retain or associate with a sample. In some aspects the strength between the sample-surface bonds or other associations can be improved, enhancing throughput and reducing cost. Various embodiments of methods of forming and/or activating/reactivating at least a portion of a metal oxide surface (or portion of a surface) of a substrate (e.g., a sequencing slide, flowcell, etc.) are disclosed herein. For example, in some embodiments, methods can include forming an activated sequencing slide or substrate which includes providing, depositing, and/or adding a metal oxide coating, portion, or layer directly or indirectly onto or in a slide or substrate. In some embodiments, methods can also include subjecting the substrate or a metal oxide coating of the substrate to a treatment or activation protocol or process. Treatment and activation protocols can cause or assist a metal oxide coating to exhibit improved ability to bind, retain, associate with, etc. at least one biological sample as compared to a substrate or coating which has not been subjected to the treatment or activation protocol. Various examples of protocols (e.g., oxygen plasma treatments, peroxide solution treatments, hydrogen peroxide, potassium hydroxide, acid/base treatments, etc.) are discussed herein.

In some embodiments, treated or activated sequencing slides are provided. For example, such slides can include a substrate having a surface. The slides can also include a metal oxide layer disposed on at least a portion of the surface, the metal oxide layer exhibiting enhanced ability to bind, retain, associate with, etc. a biological sample (e.g., an oligonucleoide, a polynucleotide, DNA, etc.), substrate, or substrate having an associated biological sample following a treatment and/or activation protocol as compared to the ability of the metal oxide layer, substrate, or a substrate having an associated biological sample to bind the biological sample prior to the activation protocol.

Various other embodiments, including methods, compositions, and kits are provided herein.

### BRIEF DESCRIPTION OF THE DRAWINGS

FIG. 1 is a schematic side view of a substrate comprising a zirconium oxide surface and depicting a nucleic acid bound to the zirconium oxide surface according to some embodiments of the present disclosure;

FIG. 2A shows the water contact angle of an untreated zirconium oxide surface according to an some embodiments of the present disclosure; and

FIG. 2B shows the water contact angle of a treated zirconium oxide surface according to some embodiments of the present disclosure.

These and other aspects, advantages, and novel features of the various embodiments of the present disclosure will become apparent upon reading the following detailed description and upon reference to the accompanying drawings. In the drawings, similar elements have similar reference numerals.

### DETAILED DESCRIPTION

Methods of improving the ability of a surface or at least a portion of a surface of a substrate (e.g., a flowcell or at least a channel of a flowcell) to receive biological samples and/or improving the surface's ability to retain such samples during various processing steps (e.g., introduction of reagents and/or wash steps) as well as the improved surfaces themselves are disclosed herein. The substrate can be an activated sequencing slide utilized during NGS techniques wherein, depending on the sequencing platform and associated chemistries, various biological samples (e.g., oligonucleotides, polynucleotides, polynucleotides tethered to beads) are deposited, immobilized, and/or grown on or relative to the surface of the substrate. For example, such improved surfaces can be utilized with the SOLiD Sequencing System of Life Technologies (Carlsbad, Calif.).

In some embodiments, methods of forming an activated sequencing slide are provided herein. The methods can include depositing a metal oxide coating/layer (e.g., a zirconium oxide coating/layer) on at least a portion of a substrate, and subjecting the substrate or subjecting at least the metal oxide coating/layer to an activation and/or treatment protocol such that the metal oxide coating exhibits an improved ability to bind and/or retain at least one biological sample as compared to a substrate and/or a metal oxide coating/layer on a substrate which has not been subjected to the treatment and/or activation protocol.

In some embodiments, the activation/treatment protocol can include treating the metal oxide coating with a peroxide solution (e.g., a hydrogen peroxide solution). In some embodiments, the activation/treatment protocol includes an oxygen plasma treatment. In some embodiments, the protocol can include potassium hydroxide. In some embodiments, the activation/treatment protocols can include various semiconductor surface cleaning treatments as well as acid and/or base treatment or a combination of these methods. Examples of acid treatments are piranha solution (e.g., 1:5 H₂O₂:H₂SO₄ hydrogen peroxide to sulfuric acid). Examples of base solution would be sodium hydroxide solution, potassium hydroxide solution, etc. In some embodiments, treatments include the use of an RCA clean (which comprises one and/or two steps, step one referred to as SC-1 and step two referred to as SC-2). SC-1 (standard clean one) is NH₄OH:H₂O₂:H₂O (e.g., 1:1:5) or dilute SC-1 (e.g., 1:4:200 of the same). SC-2 (standard clean 2) is H₂O:HCl:H₂O₂ (e.g., 5:1:1).

In some embodiments, methods include storing the substrates at a temperature below room temperature for a period of time, and then subjecting the substrate or subjecting at least the metal oxide coating of the substrate to another treatment protocol such that the metal oxide coating exhibits an improved ability to bind and/or retain at least one biological sample as compared to a metal oxide coating on a substrate which has not been subjected to the another treatment protocol.

In some embodiments, methods for activating at least a portion of a surface of a substrate for use in polynucleotide sequencing are provided. The methods can include providing a substrate having a metal oxide layer disposed on at least portions of the substrate (e.g., a continuous or discontinuous layer), and subjecting the substrate to an activation protocol configured to provide an activate substrate which exhibits an improved ability to retain a polynucleotide during a sequencing process as compared to the ability of the substrate prior to being subjected to the activation protocol to retain the polynucleotide during the sequencing process. The methods can also include providing the activated substrates for use in a polynucleotide sequencing process.

In some embodiments, the present disclosure provides activated sequencing slides. The slides include a substrate having a surface, and a metal oxide layer disposed on at least a portion of the surface wherein the metal oxide layer exhibits enhanced ability to bind and/or retain a biological sample following an activation protocol as compared to the ability of the metal oxide layer to bind the biological sample prior to the activation protocol.

U.S. Patent Application Publication No. 2010/0086927, application Ser. No. 12/508,539, filed Jul. 23, 2009, entitled “Deposition of Metal Oxides Onto Surfaces as an Immobilization Vehicle for Carboxylated or Phosphated Particles or Polymers,” the entirety of which is incorporated herein by reference, provides a substrate (e.g., a sequencing slide) having a metal oxide surface. As detailed in this application, the metal oxide surface (e.g., a zirconium oxide coating) can be utilized to bind biological samples (e.g., carboxylated or phosphated particles).

However, the ability of such metal oxide surfaces to bind, retain, etc. carboxylated or phosphated particles, polymers, or other samples, i.e., the activity of the metal oxide surface, can diminish over time. For example, the binding sites of a metal oxide surface, e.g., the metal atoms, may form other complexes or become passivated, and no longer have the ability to bind, retain, etc. the desired particles, polymers, or sample. The decrease in binding ability may be slowed, for example, by storing a slide or flow cell having a metal oxide surface in a cool environment to slow the process. If not stored in a cool environment, the binding properties of a slide coated with metal oxide may diminish in a matter of weeks. As detailed below, the methods of the present disclosure can activate and/or reactivate such metal oxide surfaces thereby improving the ability of the metal oxide surface to receive and/or retain sample.

The present disclosure provides various embodiments of treating a surface of the substrate so as to improve the surface's ability to receive and/or retain any type of biomoleucle. For example, in some embodiments, methods of activating and/or reactivating a metal oxide surface of a substrate (e.g., a flowcell or at least a surface of a channel within a flowcell) prior to immobilization and/or growth of carboxylated, phosphated, or amino-terminated particles or polymers (or other biological samples) to increase and/or maintain the ability of the surface to bind the particles or polymers are provided herein. As detailed below, in some embodiments, the methods include an oxygen plasma treatment configured to activate/reactivate a surface of the substrate. In some embodiments, the methods include a peroxide solution (e.g., hydrogen peroxide) treatment configured to activate/reactive the surface. In some embodiments, kits are provided which include the surface to be activated/reactivated and the activating/reactivating material (e.g., an aliquot of a peroxide solution). Once activated/reactivated, the activated/reactivated surface (e.g., flowcell) is obtained which is configured to show maintained or improved ability to effectively bind biological samples as compared to the untreated substrate thereby allowing for massively parallel sequencing procedures and/or analyte detection procedures.

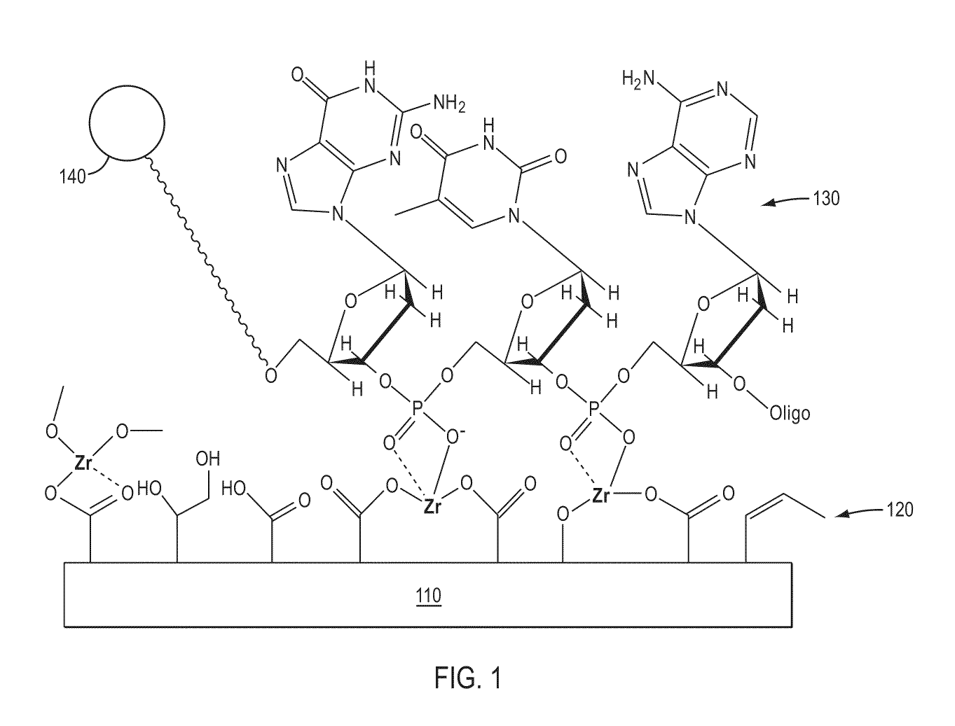

FIG. 1 provides one embodiment of a sample deposited, immobilized, and/or grown on a surface of a substrate. As detailed below, various samples and/or various substrates having various surfaces are within the spirit and scope of the present disclosure. For example, as shown in FIG. 1, the sample 130 can include an oligonucleotide or polynucleotide tethered (or attached chemically or physically by any means) to a bead (or other solid support) 140 wherein the polynucleotide and/or the bead is then deposited and/or immobilized on the surface 120 of the substrate (e.g., flowcell or within a channel of a flowcell) 110. In this example, phosphate groups of a nucleic acid sample 130 are bound to a zirconium oxide surface 120 of the substrate 110. As detailed below, the present disclosure provides methods of activating the surface 120 of the substrate 110 prior to deposition, immobilization, and/or growth of the sample on the surface thereby enhancing reactivity of the surface and/or increasing the bonding strength between the sample and the surface.

Various substrates 110 are within the spirit and scope of the present disclosure. For example, the substrate 110 can be any type of substrate 110 utilized with microarray technologies, sequencing technologies, biomolecular sensor technologies, etc. In short, the substrate 110 can be any type of substrate 110 configured for retaining any type of biomolecule(s) at any number and/or orientation of locations on the surface 120 of the substrate 110. In some embodiments, the substrate 110 can be a flow cell having any number of chambers and/channels configured to receive samples, the substrate 110 can have a plurality of wells on the surface 120, the substrate 110 can be a porous structure having sample located with the various pores, etc. In some embodiments, the surface of the substrate can have ridges or other such features so as to allow for ordered deposition or immobilization of samples on the surface of the substrate.

The substrate 110 can be formed of a single, continuous material, a combination of materials, a blend of materials, etc. In some embodiments, the substrate 110 can be layered wherein at least the surface (e.g., the top and/or bottom layer) is treated and/or improved thereby improving the ability of the surface to receive and/or retain biological material. In some embodiments, the layers are not continuous layers. For example, in some embodiments, only portions of the top layer are configured to receive and/or retain biological samples. In some embodiments, the substrate 110 can include an enclosed reaction chamber (e.g., within a channel of a flowcell) wherein various portions of the flowcell are treated to enhance reactivity relative to an untreated surface. For example, a reaction chamber can include a top surface and a bottom surface which, in addition to, for example, side walls, define at least one reaction chamber. In such an embodiment, the top surface and the bottom surface (or at least portions of the top and bottom surfaces) can be treated to improve the reactivity of at least each such surface thereby allowing for biological samples to be deposited, immobilized, and/or grown on multiple surfaces (e.g., top and bottom walls) of a reaction chamber.

As utilized in accordance with some embodiments herein, the following terms, unless otherwise indicated, shall be understood to have the following meanings:

The phrase “metal oxide surface” and variations thereof refer to a surface of a substrate that comprises an oxide of a metal. For example, the metal oxide may comprise oxides of silicon, aluminum, germanium, gallium, titanium, tantalum, indium, zirconium, magnesium, tin, gold, silver, hafnium, vanadium, niobium, molybdenum, tungsten, chromium, iron, and cobalt. The metal oxide surface need not be a continuous surface. In at least one embodiment, the metal oxide surface may be discontinuous and relatively localized at one or more positions along a substrate. In some embodiments, the substrate can be a layered substrate. In some embodiments, the top layer is a metal oxide layer, such as a zirconium oxide layer.

The term “activate” and variations thereof refer to treating a surface, such as, for example, a metal oxide surface, to increase the ability of a metal oxide surface to bind and/or retain a biological sample (e.g., a functionalized particles or particles). The increase in activity may be the result of oxidizing the metal oxide surface or removing agents that may have passivated the metal oxide surface. The increase in activity may be determined in various manners. For example, any of a variety of activation parameters can be determined after the activation/treatment step and a level of activation can be quantitatively determined by comparing a post-activation/treatment parameter/measure of the surface versus a pre-activation/treatment parameter/measure for the surface. For example, such increased activity may be determined by increased hydrophilicity, as measured, for example, by the contact angle of the surface; by a decrease in the amount of carbon detected on the surface, as measured, for example, by x-ray photoelectron spectroscopy; by an increase in the amount of sample on the surface; or by a decrease in the amount of sample lost from the metal oxide surface during a sequencing run, wherein the increase or decrease is determined by comparison with a metal oxide surface that has not been treated according to the present teachings; and/or by TOF-SIMS analysis. The term activate may also apply to the reactivation of a metal oxide surface that has previously been activated. For example, a metal oxide surface may have been activated by exposure to an oxygen plasma, hydrogen peroxide, and/or potassium hydroxide, but through the passage of time, the ability of the metal oxide surface to bind functionalized particles or polymers may have diminished. Thus, in some embodiments, the surface may be retreated by the same or a different treatment scheme (e.g., initially activated by treatment with hydrogen peroxide and later treated with an oxygen plasma treatment and/or potassium hydroxide or any such combination or sequence of treatments) at a later point in time (e.g., immediately after the first treatment or after any other period of time—e.g., days, weeks, months, years) in order to reactivate or at least partially reactivate a previously activated surface to restore, maintain, or at least improve the ability of the metal oxide surface to bind the sample. For example, such substrates may be provided as a kit which includes the substrate as well as the activation/reactivation treatment material (e.g., hydrogen peroxide, components and/or instruction relating to an oxygen plasma treatment, etc.) thereby allowing a user to activate/reactive the surface immediately (or at least at some desired point in time) prior to use.

In some embodiments, the present disclosure provides methods of activating and/or reactivating a metal oxide surface prior to immobilizing, depositing, and/or growing a sample (e.g., a functionalized particle, polymer, polynucleotide, etc.) onto the metal oxide surface. In some embodiments, the sample can include phosphated moieties, carboxylated moieties, amino group terminated oligomers, or a combination thereof. For example, in some embodiments, the phosphated moieties are derived from phosphodiester linkages selected from the group consisting of a nucleic acid, an oligonucleotide or a biomolecule containing nucleic acids, carboxylates, phosphonates, or phosphates. The phosphated moieties can bind to the metal atoms on a metal oxide surface. In some embodiments, the phosphate moieties and/or the biological sample itself can be modified in some manner (e.g., sample can undergo a terminal deoxynucleotidyl transferase (TdT) reaction) to assist in binding strength. Those skilled in the art will recognize that any biological sample modified in any manner so as to allow the biological sample to be deposited, immobilized, and/or grown on the surface of the substrate is within the spirit and scope of the present disclosure.

In some embodiments, phosphorous in the Zr bonding moiety may be bonded to one or more oxygen, nitrogen, sulfur or selenium with a combination of single or double bonds. The phosphorous may be additionally bound to alkyl or aryl. The phosphorous compounds may include but are not limited to phosphate, phosphonate, phosphorothioate, phosphorodithioate, phosphoroselenoate, phosphoramide, phosphodiester, triphosphate, oligo- and poly-phosphate groups. As appreciated by those skilled in the art, the bonding moiety can include any phosphorous containing moiety.

In some embodiments, the sample can be attached (e.g., tethered, bound, etc.) to some type of solid support. For example, in some embodiments the solid support can include a functionalized particle having a carboxylated or phosphated moiety attached thereto. The particle can be chosen from a bead, a refractory bead, or a ligation bead. In at least one embodiment, the particle is composed of a material chosen from organic polymers, silicate polymers, alumina, titania, zirconia, and combinations thereof while the surface is a glass, a metal, a metal oxide or an organic polymer.

In some embodiments, the metal oxide surface may comprise a metal oxide chosen from oxides of silicon, aluminum, germanium, gallium, titanium, tantalum, indium, zirconium, magnesium, tin, gold, silver, hafnium. In accordance with at least one embodiment, the metal oxide comprises zirconium oxide.

In some embodiments, the metal oxide surface may be positioned on a single- or multi-layer substrate. The metal oxide surface may cover an entire surface of a substrate (e.g., a top surface), or one or more areas on substrate. In some embodiments, the metal oxide surface may be present on at least one area of a surface of a substrate.

In some embodiments, the metal oxide surface is activated and/or reactivated in order to enhance the surface's ability to receive biological samples. For example, in the method disclosed in U.S. patent application Ser. No. 12/508,539, incorporated by reference in its entirety herein, a glass surface is activated with an oxygen plasma in order to allow for the glass surface to receive a metal oxide coating (e.g., zirconium oxide). However, reactivity of the zirconium oxide layer rapidly decreases as a result of at least the reasons discussed above. That is, with the passage of time, the metal oxide surface may become passivated, or the metal oxide surface may form a complex with other agents. A metal oxide surface on a slide or flow cell, for example, may experience a decrease or failure in its ability to bind sample. This diminishment of binding ability may cause the sample (e.g., functionalized particles or polymers) to be washed off, lost, or displaced during a sequencing run, leading to poor results.

In the present disclosure, methods are provided wherein the substrate having the metal oxide surface can be activated with an activation treatment. Activating or reactivating the metal oxide surface may improve the sequencing results by providing an increased number of binding sites such that the metal oxide surface may firmly bind the functionalized particles or polymers such that they remain attached in a single position during a sequencing run. In some embodiments, this activated surface can be frozen or stored in a below room temperature storage device in order to maintain the surface's activity or at least slow down the surface's deactivation. In some embodiments, the present disclosure teaches another activation step following storage in order to reactive the metal oxide layer. In some embodiments, the present disclosure provides storing (e.g., freezing) of the substrates following addition of the metal oxide layer and performing the activation step(s) following storage (e.g., substrates are thawed and then activated upon thawing) of the substrates.

Various activation/reactivation treatments are within the spirit and scope of the present disclosure. In fact, any treatment of a metal oxide surface such that the metal oxide surface show improved ability to receive, bind, retain, etc. any type of biological moiety as compared to the surfaces ability to receive, bind, retain, such samples prior to the treatment is within the spirit and scope of the present disclosure. For example, in some embodiments, oxygen plasma treatment can be utilized to restore, maintain, improve, etc. the ability of the metal oxide surface to bind the biological sample (e.g., the functionalized particles or polymers). The oxygen plasma treatment can clean the metal oxide surface and/or can oxidize the metal oxide surface, and thus increase the number of potential binding sites on the metal oxide surface.

In some embodiments, a zirconium oxide surface may be exposed to a low pressure oxygen plasma treatment. In at least one embodiment, a metal oxide surface that has previously been activated may be treated to restore its binding ability by exposing the metal oxide surface to an oxygen plasma treatment.

More specifically, in some embodiments, the substrate is a sequencing slide having a zirconium oxide surface which can be activated to allow for a covalent linkage of a sample (e.g., a P1 DNA beads after ePCR). The process includes depositing a zirconium oxide layer on plasma treated glass slides using Zirconium(IV) Ethoxide in ethanol and glacial acetic acid. The reaction can be done under argon and in a dedicated reaction vessel to help maintain anhydrous conditions. After deposition of zirconium, the slides can be washed in 2 rounds of ethanol. Then the slides can be dried in a vacuum oven at 50° C.

After drying, the sequencing slides can be activated in accordance with the various embodiments of the present disclosure. That is, the slides can be introduced to an oxygen plasma chamber and remain within the chamber for a predetermined amount of time (e.g., about 1 minute) at desired reaction parameters in order to improve and/or enhance activity of the slides. Following this oxygen plasma treatment, the slides can be packaged in slide boxes and vacuum sealed in pouches. The slides can be stored below room temperature (e.g., at about −20° C.) until ready to use or ship. In some embodiments, another activation step (e.g., another oxygen plasma treatment) can be performed immediately prior to use.

In some embodiments, a metal oxide surface can be treated by a method comprising a peroxide treatment to improve the binding ability of the metal oxide surface. In some embodiments, the peroxide can be hydrogen peroxide. Similar to the above-described oxygen plasma treatment, the peroxide treatment can oxidize the metal oxide surface or remove agents that may have passivated the metal oxide surface. The peroxide treatment therefore may increase the number of available binding sites, which improves the binding ability of the metal oxide surface. In some embodiments, the method of treating the metal oxide surface comprises exposing the metal oxide surface to a solution of hydrogen peroxide for a time sufficient to improve the binding properties of the metal oxide surface.

Without wishing to be limited by theory, it is believed that hydrogen peroxide solutions can contain stabilizers or other additives that can contaminate the metal oxide surface and/or interfere with binding of particles or polymers to the metal oxide surface. Therefore, in some embodiments, the hydrogen peroxide solution can be substantially devoid of stabilizers or other additives that contaminate the metal oxide surface and/or interfere with binding of particles or polymers to the metal oxide surface. Stabilizers that do not contaminate the metal oxide surface and/or interfere with binding of particles or polymers to the metal oxide surface can be present in certain embodiments. In some embodiments, the hydrogen peroxide solution is not substantially devoid of stabilizers and/or other additives.

In some embodiments, a metal oxide surface is exposed to about a 3% hydrogen peroxide solution for a time period ranging from about 30 seconds to about 10 minutes, for example, from about 2 minutes to about 3 minutes. Following exposure with the hydrogen peroxide solution, the metal oxide surface can be rinsed with a rinsing solution one or more times. In at least one embodiment, the metal oxide surface is rinsed at least 3 times with the rinsing solution. In other embodiments, the hydrogen peroxide solution can be anywhere between about 1% hydrogen peroxide and about 5% hydrogen peroxide. Those skilled in the art will appreciate that various other concentrations of hydrogen peroxide solutions are within the spirit and scope of the present disclosure.

Various rinsing solutions are within the spirit and scope of the present disclosure. Examples of rinsing solutions that may be used include, but are not limited to, buffering compounds, such as, for example, Tris, borates, phosphates, etc.; deposition buffers; salt solutions, such as, for example, a sodium chloride solution; and water. One skilled in the art would recognize that the rinsing solution may be chosen based on the properties of the metal oxide surface, possible interactions or reactions with the metal oxide surface, the properties of the functionalized particles or polymers, the binding properties between the metal oxide surface and the functionalized particles or polymers, etc. In some embodiments, the treatment can include adding ethanol or something similar to yield residue free and fast drying slides prior to sample/bead/template deposition.

In some embodiments, the substrate is a flowcell having a number of channels wherein each channel has a surface or portion thereof capable of being activated/reactivated by a presently disclosed activation/treatment agent and/or protocol. In some embodiments, the flowcell is used in conjuction with a sequencing system, e.g., the SOLiD Sequencing System of Life Technologies (Carlsbad, Calif.) wherein a portion of the channels of the flowcell can be utilized for performing various runs while at least one channel remains idle thereby saving reagent costs. In some embodiments, those unused lanes can be activated/reactivated at a later point in time such that those lanes can then be utilized in a sequencing run. For example, in some embodiments, those originally unused lanes can be treated with a activation agent (e.g., hydrogen peroxide solution, potassium hydroxide solution, etc.) thereby reactivating those lanes and allowing those lanes to be used despite the other lanes of the flowcell and the flowcell itself already passing through a sequencing run.

In some embodiments, functionalized particles or polymers may be deposited, immobilized, and/or grown on the metal oxide surface immediately after activation and/or reactivation of the metal oxide surface. In some embodiments, kits are provided which include the substrate and an aliquot of the activation/reactivation materials (and/or activation/reactiviation instructions) such that a user can perform the activation/reactivation treatment at any desired time prior to use.

### EXAMPLES

The following example is provided solely for explanation purposes and in no way is meant to limit the scope of the disclosure and/or any claim of this application or patent issuing therefrom.

A glass slide coated with zirconium oxide was placed in a bead deposition chamber and 3% hydrogen peroxide was added to the bead deposition chamber to cover the glass slide. The slide was exposed to the hydrogen peroxide for 2 minutes. After 2 minutes, the hydrogen peroxide was removed from the chamber via pipetting, and the zirconium oxide surface was rinsed 3 times with a rinsing solution. After rinsing, the rinsing solution was removed. Then beads comprising nucleic acids were added to the bead deposition chamber and immobilized on the zirconium oxide surface using a standard bead deposition procedure. The slides were then sequenced using the SOLiD™ sequencing system developed by Applied Biosystems (now Life Technologies Corporation of Carlsbad, Calif.). The surface activity of the treated zirconium oxide surface was determined by comparing the bead loss observed as compared to a zirconium oxide surface not treated with hydrogen peroxide.

In one study, after 25 ligation cycles, 0.9% of the beads were lost on a slide comprising a zirconium oxide surface treated with hydrogen peroxide. A bead loss of 6.9% was observed for the slide comprising an untreated zirconium oxide surface.

In another study, after 50 ligation cycles, the hydrogen peroxide treated slide lost 11.5% of the beads originally bound to the zirconium oxide surface. The untreated slide lost 31.5% of the beads.

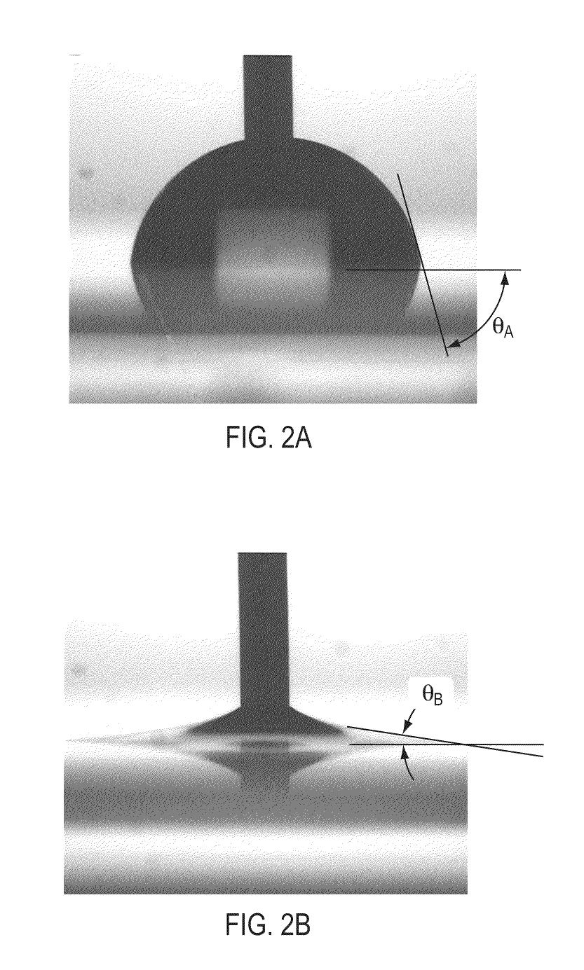

The effect of the hydrogen peroxide surface was observed by the surface wet-ability of the zirconium oxide surface. In FIG. 2A, the water contact angle, θ_{A}, approached 90° for a zirconium oxide surface that was not treated with hydrogen peroxide. FIG. 2B shows a zirconium oxide surface treated with hydrogen peroxide according to the method set forth above. As seen in FIG. 2B, the water contact angle, θ_{B}, of the treated zirconium oxide surface was substantially decreased, indicating a more hydrophilic surface. Without wishing to be limited by theory, it is believed that a large contact angle subjects beads to more lateral force than a smaller contact angle, which causes beads to become dislodged during a sequencing run.

While the principles of the present teachings have been described in connection with specific embodiments of metal oxide surfaces and sequencing platforms, it should be understood clearly that these descriptions are made only by way of example and are not intended to limit the scope of the present teachings or claims. What has been disclosed herein has been provided for the purposes of illustration and description. It is not intended to be exhaustive or to limit what is disclosed to the precise forms described. Many modifications and variations will be apparent to the practitioner skilled in the art. What is disclosed was chosen and described in order to best explain the principles and practical application of the disclosed embodiments of the art described, thereby enabling others skilled in the art to understand the various embodiments and various modifications that are suited to the particular use contemplated. It is intended that the scope of what is disclosed be defined by the following claims and their equivalents.

The section headings used herein are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used, for example, for nucleic acid purification and preparation, chemical analysis, recombinant nucleic acid, and oligonucleotide synthesis. Enzymatic reactions and purification techniques are performed according to manufacturer's specifications or as commonly accomplished in the art or as described herein. The techniques and procedures described herein are generally performed according to conventional methods well known in the art and as described in various general and more specific references that are cited and discussed throughout the instant specification. See, e.g., Sambrook et al., Molecular Cloning: A Laboratory Manual (Third ed., Cold Spring Harbor Laboratory Press, Cold Spring Harbor, N.Y. 2000). The nomenclatures utilized in connection with, and the laboratory procedures and techniques described herein are those well known and commonly used in the art.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

What is claimed is:

1. A method of forming an activated sequencing slide, comprising:
depositing a metal oxide coating on a substrate; and
subjecting at least the metal oxide coating to a treatment protocol such that the metal oxide coating exhibits an improved ability to bind and/or retain at least one biological sample as compared to a metal oxide coating on a substrate which has not been subjected to the treatment protocol.

2. The method of claim 1, wherein the treatment protocol includes treating the metal oxide coating with a peroxide solution.

3. The method of claim 2, wherein the peroxide solution comprises a hydrogen peroxide solution.

4. The method of claim 1, wherein the treatment protocol includes an oxygen plasma treatment.

5. The method of claim 1, further comprising storing the substrates at a temperature below room temperature for a period of time, and then subjecting at least the metal oxide coating to another treatment protocol such that the metal oxide coating exhibits an improved ability to bind and/or retain at least one biological sample as compared to a metal oxide coating on a substrate which has not been subjected to the another treatment protocol.

6. The method according to claim 1, wherein the metal oxide surface comprises a zirconium oxide surface.

7. The method of claim 1, wherein the substrate includes at least a top layer and a bottom layer, the top layer comprising a zirconium oxide layer.

8. The method of claim 1, wherein the treatment protocol includes treating the metal oxide coating with a potassium hydroxide solution.

9. The method of claim 1, wherein the biological sample is coupled to a solid support.

10. The method of claim 9, wherein the solid support is a bead.

11. The method of claim 1, wherein the substrate is a flowcell having at least one channel, the metal oxide layer being located within the at least one channel.

12. A method activating a surface of a substrate for use in polynucleotide sequencing, comprising:
providing a substrate having a metal oxide layer disposed on at least portions of the substrate;
subjecting the substrate to an activation protocol configured to provide an activate substrate which exhibits an improved ability to retain a polynucleotide during a sequencing process as compared to the ability of the substrate prior to being subjected to the activation protocol to retain the polynucleotide during the sequencing process; and
providing the activated substrates for use in a polynucleotide sequencing process.

13. The method of claim 12, wherein the activation protocol includes an oxygen plasma treatment.

14. The method of claim 12, wherein the activation protocol includes a peroxide solution treatment.

15. The method of claim 14, wherein the peroxide solution includes a hydrogen peroxide solution.

16. The method of claim 12, wherein the metal oxide layer is discontinuous relative to the substrate.

17. The method of claim 12, wherein the metal oxide layer is continuous relative to the substrate.

18. An activated sequencing slide, comprising:
a substrate having a surface; and
a metal oxide layer disposed on at least a portion of the surface, the metal oxide layer exhibiting enhanced ability to bind a biological sample following an activation protocol as compared to the ability of the metal oxide layer to bind the biological sample prior to the activation protocol.

19. The sequencing slide of claim 18, wherein the metal oxide layer includes zirconium oxide.

20. The sequencing slide of claim 18, wherein the substrate is layered.
